(19) United States
(12) Patent Application Publication
(10) Pub. No.: US 2026/0359481 A1
(43) Pub. Date: Nov. 12, 2026

(54) SYSTEMS AND METHODS FOR OFFLOADING PROCESSING WHILE MAINTAINING DATA PRIVACY

(71) Applicant: The Toronto-Dominion Bank, Toronto (CA)

(72) Inventors: Vipul Kishore LALKA, Oakville (CA); Venkatanarayanan MAHALINGHAM, Kitchener (CA); Shivani OBEROI, Toronto (CA); Ayda YORUKOGLU, Toronto (CA); Arnav Kumar MUNSHI, Toronto (CA)

(73) Assignee: The Toronto-Dominion Bank, Toronto (CA)

(21) Appl. No.: 19/203,409

(22) Filed: May 9, 2025

(51) Int. Cl. G06F 21/62; H04L 9/40

(52) U.S. Cl. CPC G06F 21/6254; H04L 63/0421

(57) ABSTRACT

The present application relates to systems and methods for offloading processes to a third-party computer system while maintaining data privacy using an artificial intelligence anonymizing engine. The systems and method retrieve record data from a logical storage; generate a predicted operation based on the record data; generate an anonymized dataset with an artificial intelligence anonymizing engine; assign an identifier to the anonymized dataset and the predicted operation to produce a shareable data record; offload the shareable data record to one or more third-party computer systems to generate an output that satisfies the predicted operation; receive the output; and direct at least one of the outputs from the at least one third-party computer system to the logical storage associated the entity.

### TECHNICAL FIELD

The present application relates to data processing and, more particularly, to systems and methods for offloading processes to a third-party computer system while maintaining data privacy using an artificial intelligence anonymizing engine.

### BACKGROUND

Offloading processing to another computer system, also known as distributed computing or remote processing, involves delegating specific computational tasks from a primary system to a secondary system to enhance efficiency and performance. This strategy is particularly useful when the primary system is under heavy load or lacks the necessary computational power to efficiently handle resource-intensive tasks. This not only alleviates the burden on the primary system, allowing it to maintain optimal performance for other tasks, but also leverages the combined processing power of multiple systems to achieve faster and more efficient results. This approach not only improves overall system performance but also ensures that demanding applications run smoothly without causing bottlenecks.

### BRIEF DESCRIPTION OF THE DRAWINGS

Embodiments are described in detail below, with reference to the following drawings:

FIG. 1 is a schematic operation diagram illustrating an operating environment;

FIG. 2 is a logical block diagram of a remote-computing system;

FIG. 3 is a high-level operation diagram of a resource server;

FIG. 4 is a high-level software architecture executing on a computing device;

FIG. 5 is a high-level schematic diagram on a parallel processing architecture;

FIG. 6 is a block diagram of a training system for the parallel processing architecture;

FIG. 7 is a flowchart demonstrating a third-party offloading method;

FIG. 8 is a flowchart demonstrating a third-party offloading method operating in conjunction with a parallel computing server;

FIG. 9 is a flowchart demonstrating a third-party offloading method incorporating performance capability selection; and

FIG. 10 is a flowchart demonstrating a customization method for personalizing the output from the third-party offloading method(s).

Like reference numerals are used in the drawings to denote like elements and features.

### DETAILED DESCRIPTION

According to an aspect, there is provided a server comprising: a communications module; at least one processor coupled to the communications module; and a memory coupled to the at least one processor. The memory storing a plurality of processor-executable instructions which, when executed, configure the at least one processor to: retrieve record data from a logical storage associated with an entity, the record data comprising operation data; generate a predicted operation based on at least a portion of the record data; generate an anonymized dataset by providing the portion of the record data used to generate the predicted operation to an artificial intelligence anonymizing engine; assign an identifier to the anonymized dataset and the predicted operation to produce a shareable data record and associate the identifier with the logical storage associated with the entity; offload the shareable data record to at least one third-party computer system to generate an output that satisfies the predicted operation; receive, from the at least one third-party computer system, the output; and direct at least one of the outputs from the at least one third-party computer system to the logical storage associated the entity. The predicted operation may be generated by an artificial intelligence engine based on at least the portion of the record data and a profile associated with the logical storage, the profile comprising at least one operational preference.

The instructions may further configure the at least one processor to store the shareable data record in a database storage, the database storage being separate from the logical storage associated with the entity and the database storage accessible to the at least one third-party computer system.

The instructions may further configure the at least one processor to generate, by a content generator, a customized output for the predicted operation by injecting personal data from the record data into the output; transmit the customized output to a remote-computing system associated with the logical storage; request an acknowledgement of the customized output to initiate a transfer of the personal data to the third-party computer system associated with the customized output; and/or receive the acknowledgement from the remote-computing system responsive to a selection by the remote-computing system. The instructions may further configure the at least one processor to responsive to the acknowledgement, transmit the personal data of the entity to the third-party computer system; responsive to the acknowledgement, perform a data transfer from the logical storage to a third-party logical storage; and/or apply a modifier to the data transfer thereby transferring the modifier into a server-provider logical storage.

The instructions may further configure the at least one processor to determine an operational score for the output; and direct the output to the content generator responsive to the operational score exceeding an operational threshold.

The instructions may further configure the at least one processor to determine a score for the shareable data record; and share the shareable data record with the third-party computer system responsive to the score exceeding a threshold.

The instructions may further configure the at least one processor to generate at least one classification for the predicted operation; collate a plurality of the shareable data record based on the at least one classification; and provide the plurality of the shareable data record to the at least one third-party computer system.

According to another aspect, there is provided a computer-implemented method comprising: retrieving record data from a logical storage associated with an entity, the record data comprising operation data; generating a predicted operation based on at least a portion of the record data; generating an anonymized dataset by providing the portion of the record data used to generate the predicted operation to an artificial intelligence anonymizing engine; assigning an identifier to the anonymized dataset and the predicted operation to produce a shareable data record and associate the identifier with the logical storage associated with the entity; offloading the shareable data record to at least one third-party computer system to generate an output that satisfies the predicted operation; receiving, from the at least one third-party computer system, the output; and directing at least one of the outputs from the at least one third-party computer system to the logical storage associated the entity.

The predicted operation may be generated by an artificial intelligence engine based on at least the portion of the record data and a profile associated with the logical storage, the profile comprising at least one operational preference.

The method may further comprise storing the shareable data record in a database storage, the database storage being separate from the logical storage associated with the entity and the database storage accessible to the at least one third-party computer system.

The method may further comprise generating, by a content generator, a customized output for the predicted operation by injecting personal data from the record data into the output. The method may further comprise determining an operational score for the output; and directing the output to the content generator responsive to the operational score exceeding an operational threshold.

The method may further comprise transmitting the customized output to a remote-computing system associated with the logical storage; requesting an acknowledgement of the customized output to initiate a transfer of the personal data to the third-party computer system associated with the customized output; and receiving the acknowledgement from the remote-computing system responsive to a selection by the remote-computing system. The method may further comprise responsive to the acknowledgement, transmitting the personal data of the entity to the third-party computer system. The method may further comprise performing a data transfer from the logical storage to a third-party logical storage responsive to the acknowledgement; and applying a modifier to the data transfer thereby transferring the modifier into a server-provider logical storage.

The method may further comprise determining a score for the shareable data record; and sharing the shareable data record with the third-party computer system responsive to the score exceeding a threshold.

According to yet another aspect, there is provided a non-transitory computer readable storage medium comprising processor-executable instructions which, when executed, configure at least one processor to: retrieve record data from a logical storage associated with an entity, the record data comprising operation data; generate a predicted operation based on at least a portion of the record data; generate an anonymized dataset by providing the portion of the record data used to generate the predicted operation to an artificial intelligence anonymizing engine; assign an identifier to the anonymized dataset and the predicted operation to produce a shareable data record and associate the identifier with the logical storage associated with the entity; offload the shareable data record to at least one third-party computer system to generate an output that satisfies the predicted operation; receive, from the at least one third-party computer system, the output; and direct at least one of the outputs from the at least one third-party computer system to the logical storage associated the entity.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all the elements, and without necessarily excluding additional elements.

In the present application, the phrase “at least one of . . . or . . . ” is intended to cover any one or more of the listed elements, including any one of the listed elements alone, any sub-combination, or all the elements, without necessarily excluding any additional elements, and without necessarily requiring all the elements.

Example embodiments of the present application are not limited to any particular operating system, system architecture, mobile device architecture, server architecture, or computer programming language.

As described herein, computing systems, such as the resource server 130 and/or the parallel computing server 140, may reach capacity or may exceed capacity (e.g., overcapacity) as the computer processes increase. As the number of computer processes increase, the computing systems may experience performance degradation in response to processor overload, memory overload, full storages, network overload, etc. The performance degradation may be exhibited as sluggish response, longer processing times, swapping data to slower storage, application crashes, increased heat, increased power consumption, increased latency, packet loss, bandwidth saturation, network congestion, etc. In some case, the computer processes being executed may be dropped or deferred in response to the performance degradation. The deferred processes may be executed one the performance degradation subsides.

In some aspects, the computing systems may predict future operations or processes to be executed by the computing system, known herein as predicted operations. The predicted operation may comprise one or more processor-executable instructions and/or record data to be processed. The predicted operations may be predicted to alleviate performance degradation by anticipating computer processes to be performed on the record data and executing these predicted operations in advance during periods when performance degradation is not occurring. Although the predicted operations may alleviate performance degradation, in some instances, executing the predicted operations may exasperate the performance degradation when an incorrect prediction occurs as an incorrectly predicted operation is executed by the computing system. By executing the incorrectly predicted operation, the output may be discarded, and computing resources may be wasted.

The performance degradation may be addressed in several ways. For example, the resource server 130 and/or the parallel computing server 140 may distribute the computer processes across multiple resource servers 130 and/or multiple parallel computing servers 140. In another example, the resource servers 130 and/or the parallel computing servers 140 may be added. The hardware for the resource server 130 and/or parallel computing server 140 may be upgraded. The applications 410 may be optimized. These solutions result in increased costs and/or cannot be easily dynamically increased. One or more predicted operations may be considered “optional” in that the predicted operation may not be selected for execution. A provider of the resource server 130 and/or the parallel computing server 140 may be unlikely to expend finite resources on these solutions for the predicted operations that may not even be selected for execution.

Another remedy may be to offload one or more of the predicted operations to the third-party computer system 120. The offloading may be beneficial in situations where an output of the predicted operation may have some benefit to the third-party computer system 120. For example, the third-party computer system 120 may enrich its own dataset by with the predicted operations and/or their outputs. In another example, the third-party computer system 120 may refine one or more algorithms and/or analytic tools based on the predicted operations and/or their outputs.

Although offloading the predicted operations may resolve overcapacity, concerns exist regarding privacy and/or security. The privacy concerns may be particularly acute in industries regulated by privacy acts, such as healthcare, finance, education, etc., as these industries may be in contravention of these laws by offloading the predicted operations.

Various solutions for addressing the technical challenges associated offloading processing and/or addressing data privacy are described in the present disclosure.

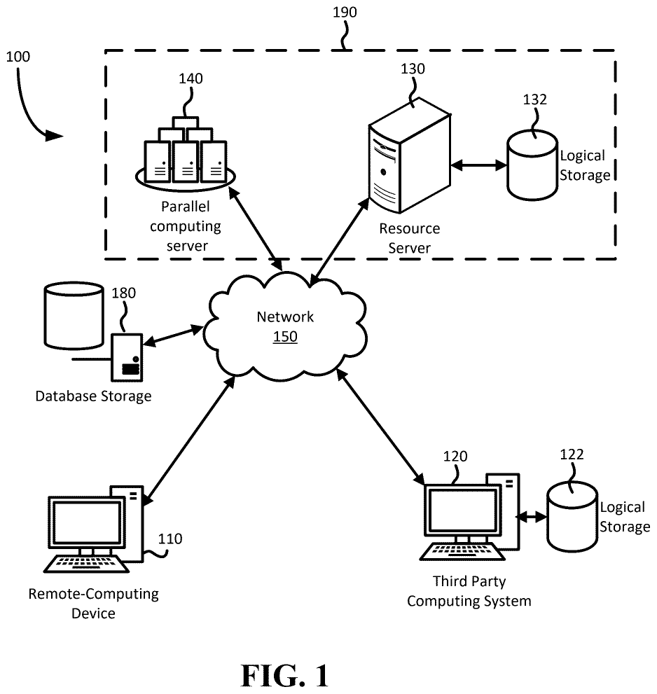

FIG. 1 is a schematic operation diagram illustrating an operating environment. As shown, a networked computing system 100 may include a remote-computing system 110, a third-party computer system 120, a resource server 130, a parallel computing server 140, and a database storage 180 coupled to one another through a network 150, which may include a public network such as the Internet and/or a private network. The remote-computing system 110 may be associated with a logical storage 132 associated with the resource server 130. The remote-computing system 110, the third-party computer system 120, the parallel computing server 140, the resource server 130, and/or the database storage 180 may be in geographically disparate locations. Put differently, the remote-computing system 110, the third-party computer system 120, the parallel computing server 140, the resource server 130, and/or the database storage 180 may be located remote from one another. In other aspects, the parallel computing server 140 and the resource server 130 may be located at the same location. In some aspects, the resource server 130, the logical storage 132, and the parallel computing server 140 may be within a private network environment 190 configured to isolate record data from the network 150. The private network environment 190 may be firewalled or otherwise isolated from the network 150 and/or may have strict access controls to access the record data and/or logical storage 132.

The resource server 130 may be referred to as an access control server and may be configured to control access to protected data stored within a plurality of logical storages 132. The resource server 130 may maintain a protected data resource storing database records for a plurality of entities. In at least some aspects, the resource server 130 may be provided by a financial institution which may maintain customer bank accounts. The protected data resource that may be logically separated into one or more logical storages 132 associated with one or more entities. The logical storages 132 may store a data record that may, for example, reflect an amount of value stored in that logical storage 132 associated with the entity. The resource server 130 may protect the logical storages 132 using bank-grade security. The resource server 130 and the remote-computing system 110 may be connected over the network 150 via a virtual private network and/or a bank-grade encryption protocol. The resource server 130 and the parallel computing server 140 may be connected over the network 150 via a virtual private network and/or a bank-grade encryption protocol.

The third-party computer system 120 may access a third-party logical storage 122. The third-party computer system 120 may retrieve third-party data, such as financial data, market data, historical data, performance metrics, etc.

While FIG. 1 illustrates the third-party computer system 120, the parallel computing server 140, the resource server 130, and the database storage 180 as single servers, more than one such server may be engaged and connected through the network 150. Further, the resource server 130 may be connected to one or more data resources such as, for example, a computer system that includes one or more database servers, computer servers, and the like. The resource server 130, the parallel computing server 140, and/or the database storage 180 may provide, for example, an application programming interface (API) for a web-based system, operating system, database system, computer hardware, and/or software library.

The computing system 100 includes at least one of the application servers executing on the resource server 130. The application server may be associated with an application 410 (such as a web or mobile application) that is resident on the remote-computing system 110 and/or the third-party computer system 120. The application 410 may retrieve and/or instruct the application server via an application programming interface (API). For example, the application server may connect the remote-computing system 110 to a back-end system associated with the application 410. The application server may be configured to perform, among others, user management, data storage, security, transaction processing, resource pooling, push notifications, messaging, and/or off-line support of the application 410. The application server may be connected to the remote-computing system 110, the third-party computer system 120, the parallel computing server 140 and/or the database storage 180 via the network 150.

The network 150 is a computer network. In some aspects, the network 150 may be an internetwork such as may be formed of one or more interconnected computer networks. For example, the network 150 may be or may include an Ethernet network, an asynchronous transfer mode (ATM) network, a wireless network, a telecommunications network, a satellite network, or the like.

The remote-computing system 110, the third-party computer system 120, the resource server 130, the parallel computing server 140, and/or the database storage 180 are computer systems. The remote-computing system 110 may take a variety of forms including, for example, a mobile communication device such as a smartphone, a tablet computer, a wearable computer such as a head-mounted display or smartwatch, a laptop or desktop computer, or a computing device of another type. In some aspects, the entity may operate the remote-computing system 110 to cause the remote-computing system 110 to perform one or more operations.

As described in further detail below, the resource server 130 may identify one or more predicted operations based on the record data stored in the logical storage 132. In some aspects, the resource server 130 may provide the record data to an operation predictor 614 for generation of the one or more predicted operations. The predicted operations may be processed by the parallel computing server 140 to anonymize the record data into an anonymized dataset. In some aspect, the anonymized dataset may be generated by an artificial intelligence anonymizing engine 612 executing on the parallel computing server 140. The anonymized dataset and the predicted operation may be combined into a shareable data record. The shareable data record may be transmitted over the network 150 and stored on the database storage 180. One or more third-party computer systems 120 may retrieve and process the shareable data record to generate an output that satisfies the predicted operation. One or more of the outputs may be provided to the resource server 130 and stored in the logical storage 132 associated with the entity. In the manner the resource server 130 and/or the parallel computing server 140 may offload at least a portion of the processing of the predicted operations to the third-party computer system 120. In some aspects, the output from more than one third-party computer system 120 may be compared and/or processed to identify an optimal output to satisfy the predicted operation.

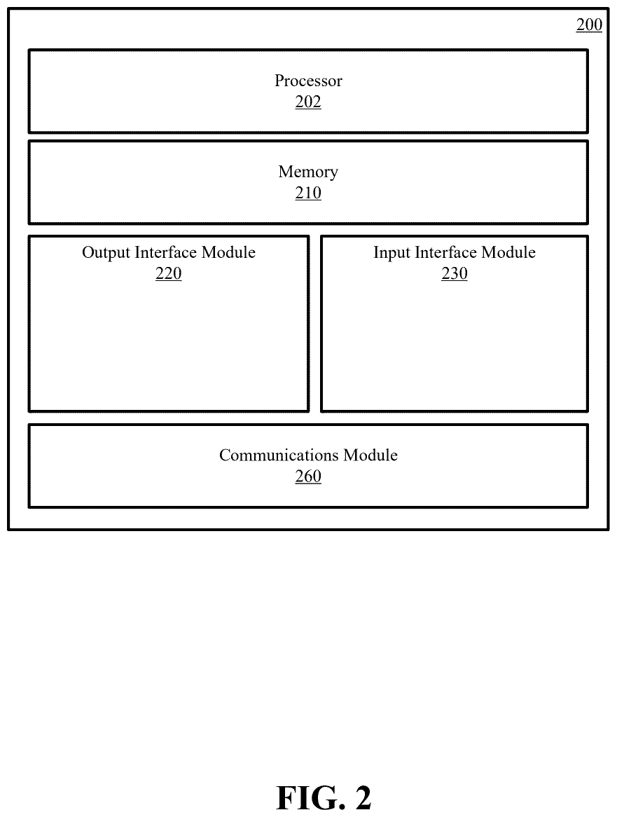

FIG. 2 illustrates components of a computing system 200, such as the remote-computing system 110 and/or the third-party computer system 120. The computing system 200 includes a variety of modules. For example, as illustrated, the computing system 200, may include a processor 202, a computer-readable memory 210 (also known as a non-transitory computer readable storage medium), an output interface module 220, an input interface module 230, and/or a communications module 260. The foregoing example modules of the computing system 200 may be in communication over a bus.

The processor 202 is a hardware processor. The processor 202 may, for example, be one or more ARM, Intel x86, PowerPC processors or the like. The processor 202 may be a single-core processor, a multi-core processor, or the like. The processor 202 may execute one or more processor-executable instructions from the computer-readable memory 210. The processor-executable instructions may be executed serially and/or in parallel in accordance with the structure of the processor 202. Although not depicted, the processor 202 may include one or more co-processors and/or integrated circuits to facilitate communication with the computer-readable memory 210, output interface module 220, input interface module 230, and/or the communications module 260.

The computer-readable memory 210 allows data and/or processor-executable instructions to be stored and retrieved. The computer-readable memory 210 may include, for example, random access memory, read-only memory, and persistent storage. Persistent storage may include, for example, flash memory, a solid-state drive or the like. Read-only memory and persistent storage are a computer-readable medium. A computer-readable medium may be organized using a file system such as may be administered by an operating system 420 governing overall operation of the remote-computing system 110. The computer-readable memory 210 may comprise a storage module for storing and retrieving data. Additionally or alternatively, the storage module may be used to store and retrieve data from persisted storage that may not be accessible via the computer-readable memory 210. In some aspects, the storage module may be used to store and retrieve data in a database. A database may be stored in persisted storage. Additionally or alternatively, the storage module may access data stored remotely such as, for example, as may be accessed using a local area network (LAN), wide area network (WAN), personal area network (PAN), and/or a storage area network (SAN). In some aspects, the storage module may access data stored remotely using the communications module 360. In some aspects, the storage module may be omitted, and its function may be performed by the computer-readable memory 210 and/or by the processor 202 in concert with the communications module 260 such as, for example, when data is stored remotely. The storage module may also be referred to as a data store.

The input interface module 230 allows the computing system 200 to receive input signals. Input signals may, for example, correspond to input received from a user. The input interface module 230 may serve to interconnect the computing system 200 with one or more input devices. Input signals may be received from input devices by the input interface module 230. Input devices may, for example, include one or more of a touchscreen input, keyboard, trackball, voice command interface, or the like. In some aspects, all or a portion of the input interface module 230 may be integrated with an input device. For example, the input interface module 230 may be integrated with one of the input devices. The input interface module 230 may include an input device allowing input to be provided to the computing system 200. Input received via the input interface module 230 may be conveyed to the processor 202. For example, the input interface module 230 may be used by the entity to provide a personal identification number (PIN) to the remote-computing system 110 as a part of authenticating a resource management application 412 executing on the remote-computing system 110 with an authentication server executing on the resource server 130.

The output interface module 220 allows the computing system 200 to provide output signals. Some output signals may, for example, allow provision of output to a user. The output interface module 220 may serve to interconnect the computing system 200 with one or more output devices. Output signals may be sent to output devices by an output interface module 220. Output devices may include, for example, a display screen such as, for example, a liquid crystal display (LCD), a touchscreen display. Additionally, or alternatively, output devices may include other output devices such as, for example, a speaker, indicator lamps (such as for example light-emitting diodes (LEDs)), and printers. In some aspects, all or a portion of the output interface module 220 may be integrated with an output device. For example, the output interface module 220 may be integrated with one of the output devices.

The communications module 260 allows the computing system 200 to communicate with other electronic devices and/or various communications networks. For example, the communications module 260 may allow the computing system 200 to send or receive communications signals. Communications signals may be sent and/or received according to one or more protocols or according to one or more standards. For example, the communications module 260 may allow the computing system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 260 may allow the computing system 200 to communicate using near-field communication (NFC), via Wi-Fi™, using Bluetooth™ or via some combination of one or more networks or protocols. In some aspects, all or a portion of the communications module 260 may be integrated into a component of the computing system 200. For example, the communications module 260 may be integrated into a communications chipset.

Software comprising a plurality of processor-executable instructions is executed by the processor 202 from a computer-readable medium. For example, software may be loaded into random-access memory from persistent storage of computer-readable memory 210. Additionally, or alternatively, processor-executable instructions may be executed by the processor 202 directly from read-only memory of computer-readable memory 210.

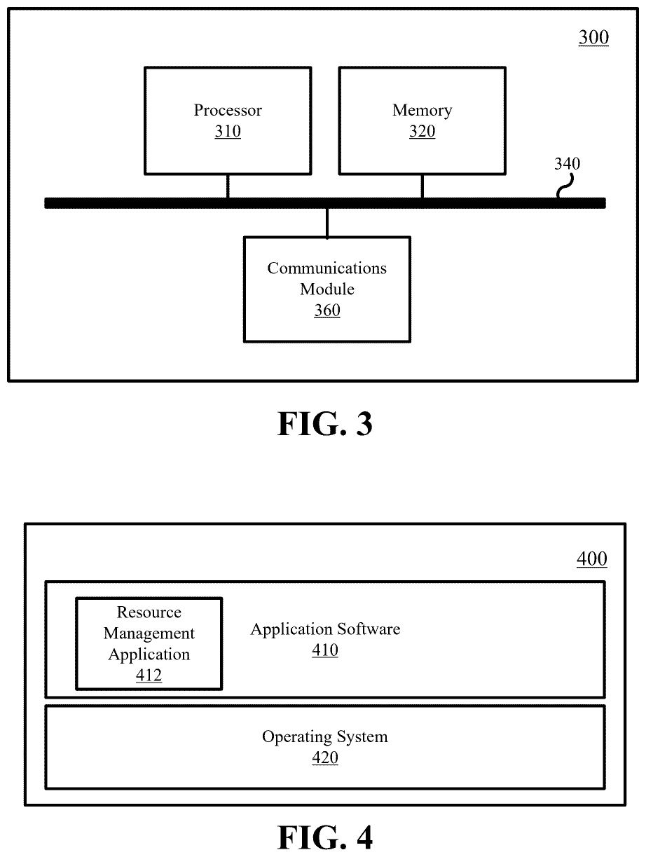

Turning to FIG. 3, the resource server 130 and/or the database storage 180 are computer server systems 300. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some aspects, a computer server system may include a cluster formed of a plurality of interoperating computing devices.

The computer server system 300 may comprise a variety of modules. For example, as illustrated, the computer server system 300 may include a processor 310, a computer-readable memory 320, and a communications module 360. These modules may communicate over a bus 340.

The processor 310 may include a hardware processor. The processor 310 may, for example, be one or more ARM, Intel x86, PowerPC processors or the like. The processor 310 may include a single-core or a multi-core processor. The processor 310 may have one or more interfaces, such as buses, ports, etc., for communicating with other hardware devices that are not illustrated to simplify the figure.

The computer-readable memory 320 allows data and/or processor-executable instructions to be stored and retrieved. The computer-readable memory 320 may include, for example, random access memory, read-only memory, and persistent storage. Persistent storage may include, for example, flash memory, a solid-state drive or the like. Read-only memory and persistent storage are non-transitory computer-readable storage mediums. A computer-readable medium may be organized using a file system such as may be administered by an operating system 420 governing overall operation of the computer server system 300.

The communications module 360 allows the computer server system 300 to communicate over the network 150 to send and receive data.

FIG. 4 depicts a simplified organization of software components 400 stored in the computer-readable memory 320 of the computer server system 300 or the computer-readable memory 210 of the computing system 200, such as the remote-computing system 110 and/or the third-party computer system 120. As illustrated these software components include an operating system 420 and an application 410. The operating system 420 is software. The operating system 420 allows the application 410 to access the processor 310, the computer-readable memory 320, and/or the communications module 360. The operating system 420 may include, for example, Apple's iOS™, Google's Android™, Linux™, Unix™, Microsoft's Windows™, Apple OSX™, or the like.

The application 410 adapts the computer server system 300 or the computing system 200, in combination with the operating system 420, to operate as a device performing functions as described herein. For example, the application 410 may cooperate with the operating system 420 to adapt a suitable aspect of the computer server system 300 to operate as the resource server 130, and/or the database storage 180. In some aspects, the application 410 may provide an application server for interfacing with an application 410 that is executing on the remote-computing system 110 and/or the third-party computer system 120. In another example, the application 410 may cooperate with the operating system 420 to adapt a suitable aspect of the remote-computing system 110 to operate as the resource management application 412. The resource management application 412 may receive data and/or provide commands to the resource management server executing on the resource server 130.

For example, in aspects where the application 410 is functioning as the application 410 executing on the third-party computer system 120, the application 410 may be configured to select and/or retrieve one or more predicted operations from the database storage 180. The application 410 may process the predicted operations in combination third-party data stored on the third-party logical storage 122 to generate the output that satisfies the predicted operation. The application 410 may transmit the output to the resource server 130. In some aspects, the application 410 may transmit the output to the database storage 180 to be stored with the shareable data record that includes the predicted operation.

While an application 410 is illustrated in FIG. 4 as a single application, in operation, the computer-readable memory 210 and/or the computer-readable memory 320 may include more than one application 410, and the applications 410 may perform different operations. For example, in aspects where the application 410 is functioning as the resource management application on the remote-computing system 110, the application 410 may be configured for secure communications with the resource server 130 and may provide various banking functions such as, for example, display of account balances, transfers of value (e.g. bill payments, money transfers), and other resource management functions.

The on-device application data may include one or more of a list of applications installed on the remote-computing system 110, levels of permission granted to the installed applications, internet search history data, and/or activity data indicating activity performed on the remote-computing system 110.

By way of further example, in at least some aspects in which the application 410 executes on the remote-computing system 110 and/or the third-party computer system 120, the applications 410 may include a web browser, which may also be referred to as an Internet browser. In at least some such embodiments, the resource server 130 may execute an application server providing a web server that may serve one or more of the interfaces described herein. The web server may cooperate with the web browser and may serve an interface when the interface is requested through the web browser. For example, the web server may serve as a mobile banking interface.

By way of further example, in at least some aspects in which the application 410 executes on the remote-computing system 110 and/or the third-party computer system 120, the application 410 may include an electronic messaging application. The electronic messaging application may be configured to display a received electronic message such as an email message, short messaging service (SMS) message, or a message of another type.

The resource server 130 may be associated with a financial institution and the financial institution may be the same financial institution associated with the remote-computing system 110. The resource server 130 and the remote-computing system 110 may perform operations to provide services to the financial institution. The resource server 130 may perform operations related to performing transactions using the remote-computing system 110. For example, the resource server 130 may perform operations related to authorizing and/or completing transactions by the remote-computing system 110. The resource server 130 may additionally or alternatively perform operations related to authenticating an entity of the remote-computing system 110. By way of example, the resource server 130 may be configured to provide a website or web-based portal which can be accessed via the remote-computing systems 110. The website (or portal) may include web content corresponding to various services offered by the business entity, and the resource server 130 may provide the web content for display on the remote-computing systems 110. As another example, the resource server 130 may be associated with a software application which may be installed and/or run on the remote-computing systems 110. More specifically, the resource server 130 may implement the backend of an application (e.g., mobile application) that is used for accessing the services offered by the business entity. For example, the resource server 130 may perform operations to authenticate an entity based on data from a card and based on a personal identification number (PIN) received as input by the remote-computing system 110.

The resource server 130 may operate in conjunction with a protected data resource, such as the logical storage 132, that stores secure data. In particular, the protected data resource may include one or more logical storage locations that may store records for accounts that are associated with various entities. The protected data resource may store sensitive data associated with the logical storage holder, such as financial data, medical data, employment data, etc. That is, the secure data may comprise account data for one or more specific entities. For example, an entity that operates the remote-computing system 110 may be associated with an account having one or more records in the protected data resource. In at least some aspects, the records may reflect a quantity of stored resources that are associated with the entity. Such resources may include owned resources and/or borrowed resources (e.g. resources available on credit). The quantity of resources that are available to or associated with a logical storage holder may be reflected by a balance defined in an associated record.

In some aspects, the logical storage 132 may store various types of information in connection with customers of an operator that administers the resource server 130. For example, the logical storage 132 may store customer profile data and financial account data associated with customers. The customer profile data may include, without limitation, personal information of registered customers, authentication credentials of the customers, account identifying information (e.g., checking account, savings account, revolving credit line, etc.), and information identifying services (e.g., banking services, investment management services, etc.) and/or programs (e.g., loyalty programs) that are offered to the customers. The financial account data may include account balances, historical transaction data, credit score(s), mortgage balances, investment account balances, and portfolio data relating to portfolios of investments that are held by customers, among others.

For example, the secure data in the protected data resource may include financial data, such as banking data (e.g. bank balance, historical transactions data, etc.) and investment data (e.g. portfolio information) for the entity. In particular, the resource server 130 may include a financial institution (e.g. bank) server and the logical storage holder may be linked to a record of an account of the financial institution which operates the financial institution server. The financial data may, in some aspects, include processed or computed data such as, for example, an average balance associated with an account, an average spending amount associated with an account, a total spending amount over a period, or other data obtained by a processing server based on account data for the entity.

In some aspects, the protected data resource, such as the logical storage 132, may include a computer system that includes one or more database servers, computer servers, and the like. In some embodiments, the protected data resource may comprise an application programming interface (API) for a web-based system, operating system, database system, computer hardware, or software library.

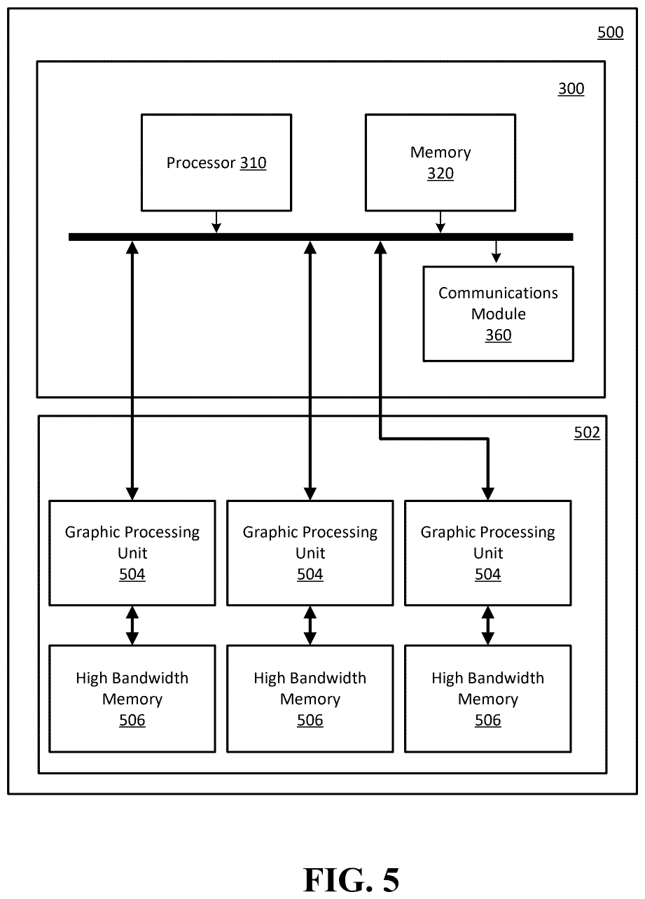

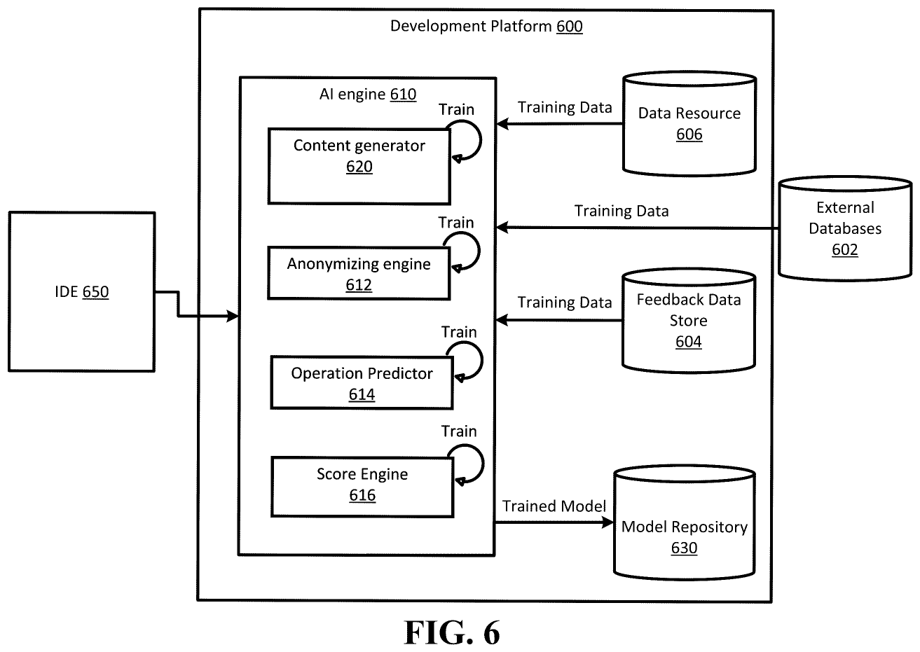

Turning to FIGS. 5 and 6, the parallel computing server 140 comprises a processing structure 500. The processing structure 500 may comprise a computer server system 300 as previously described with reference to FIG. 3. In some aspects, the computer server system 300 may be the same as the resource server 130 in that the computer server system 300 comprises the processor 310, the computer-readable memory 320, and the communications module 360. In other aspects, the computer server system 300 may be a distinct computing server. In any event, the computer server system 300 may manage a parallel computing structure 502. The parallel computing structure 502 may comprise a plurality of graphic processing units (i.e. GPUs 504) having a high-bandwidth memory 506 associated with each of the GPUs 504.

The processor 310 may execute one or more processor-executable instructions from the computer-readable memory 320 to manage a parallel computing structure 502. The processor 310 may execute a distributing module that may comprise processor-executable instructions to send, transmit, and/or distribute data to be processed to at least one of the GPUs 504. The distributing module may monitor a workload of the GPUs 504 to select the GPU 504 with available capacity. For example, the GPUs 504 may periodically post workloads to the distributing module (e.g. approximately 15-minute intervals) via an application interface. The distributing module may determine that one of the GPUs 504 has a low workload, or workload below a threshold, and in response, distribute data to be processed to that one of the GPUs 504. In some aspects, the distributing module may cooperate with a priority module to assign to the GPUs 504 a higher or greater priority before lower or lesser priority data transfers.

The parallel computing structure 502 may execute an artificial intelligence engine (i.e. AI engine 610) or more artificial intelligence (AI) engines. In this aspect, the AI engine 610 may comprise one or more replicas of an AI model, such as, but not limited to, a large language model (LLM), a multimodal LLM, a Generative Adversarial Networks (GANs), a Variational Autoencoder (VAE), a Recurrent Neural Network (RNN), a Transformer, a Diffusion Model, and/or any combination thereof executing in series, parallel, and/or recursively. For ease of reference, the replica is generally referred to as the AI engine 610. Each of the replicas may execute on one or more of the GPUs 504. One or more of these AI models may be selected based on the data and/or processing task to be performed as described in further detail herein. The processor 310 may instruct the parallel computing structure 502 to retrieve the selected AI model from a model repository 630 and load the AI model into the high-bandwidth memory 506 for execution by the GPU 504 prior to processing the data. In some aspects, a previously executing AI engine 610 that is no longer being used may be reset in preparation for the new interaction.

Turning to FIG. 6, an AI development platform 600 is shown for training one or more of the AI models (e.g. 612, 614, 616, 620) of the AI engine 610. An integrated development environment (i.e. IDE 650) may enable a provider to develop, train, and/or retrain the AI engine 610. The IDE 650 may include an application 410 with a programming interface accessible by a developer device (not shown), which may be the remote-computing system 110, over the network 150 or via a local connection. The IDE 650 may include a web application that can be accessed at a network address, uniform resource locator (URL), etc. The IDE 650 may be locally or remotely installed on the remote-computing system 110 where the IDE 650 is accessed and used locally.

The IDE 650 may be used to design an AI engine 610 using the user interface of the IDE 650. For example, the user interface may be output as part of the software application that interacts with the IDE 650. A developer may use an input mechanism to make selections from menus to add pieces to the AI engine 610, such as data components, model components, analysis components, etc., within a workspace of the user interface. The menus may include a plurality of graphical user interface (GUI) menu options, which can be selected to reveal additional components that can be added to the model design shown in the workspace. The GUI menu options may include options for adding features such as neural networks, machine learning models, AI models, data sources, conversion processes (e.g., vectorization, encoding, etc.), analytics, etc. The developer may continue to add features to the AI engine 610 and connect the features using edges and/or other means to create a flow within the workspace. For example, the developer may add a node to a flow of a new model within the workspace. For example, the developer may connect a node to another node in the flow via an edge, creating a dependency within the flow. When the developer is done, the IDE 650 can save the AI engine 610 and/or AI models for subsequent training and/or testing.

The training process for training and/or retraining the AI engine 610 may involve an executable script configured to read data from the data resource 606 and/or the external database 602 and input the data to the AI engine 610. For example, the executable script may use identifiers (IDs) of one or more data locations (e.g., table IDs, row IDs, column IDs, topic IDs, object IDs, etc.) to identify locations of the training data within the data resource 606 and query an API of the data resource 606. In response, the data resource 606 may receive the query, load the requested data, and return the data to the executable script, where the data is input to the AI engine 610. The training process may be managed via an interface of the IDE 650, allowing for supervised learning during the training process. In other aspects, the training process may perform unsupervised learning.

In some aspects, the script may iteratively retrieve additional training datasets from the data resource 606 and iteratively input the additional training datasets into the content generator 620 during the execution to continue to train the AI engine 610. The script may continue until processor-executable instructions within the script direct the script to terminate, which may be based on iterations (e.g. training loops), total time elapsed during the training process, etc.

The IDE 650 may also be used to retrain the AI engine 610 after being deployed. The training process may use executional results that have been generated or output by the content generator 620, the artificial intelligence anonymizing engine 612, and/or the operation predictor 614 in a live environment for retraining. For example, a score engine 616 may score output from the content generator 620 and/or the artificial intelligence anonymizing engine 612 and feedback those scores to retrain the content generator 620, the artificial intelligence anonymizing engine 612, and/or the operation predictor 614 to further enhance accuracy and/or relevancy. The feedback may include indications of whether the generated output scores match or exceed scores resulting from a manual evaluation, such as based on the feedback received from the entity. In yet another example, the feedback from the entity may be used to train and/or retrain the content generator 620, the artificial intelligence anonymizing engine 612, and/or the operation predictor 614 to further enhance its accuracy, relevancy, and/or reliability. The feedback data may be captured and stored within a feedback data store 604 or other data store within the live environment and can be subsequently used to retrain the score engine 616 and/or the content generator 620 and/or the artificial intelligence anonymizing engine 612 and/or the operation predictor 614.

Once trained or retrained, the AI engine 610 may store the trained AI engine 610 in a model repository 630. Although the description refers to training the AI engine 610 as a whole, the techniques apply equally well to training modules of the AI engine 610, such as the operation predictor 614, the artificial intelligence anonymizing engine 612, the content generator 620, and/or the score engine 616. The individual modules may be stored and/or retrieved separately to and/or from the model repository 630.

The AI engine 610 may comprise one or more of the modules: an operation predictor 614, an artificial intelligence anonymizing engine 612, a content generator 620, and/or a score engine 616. The AI engine 610 may execute on the parallel computing server 140 and may receive record data from the resource server 130. In some aspects, the operation predictor 614, the artificial intelligence anonymizing engine 612, the content generator 620, and/or the score engine 616 may execute on the same GPU 504 or different GPUs 504, in any combination. For instance, the operation predictor 614 and the artificial intelligence anonymizing engine 612 may execute on the same GPU 504 and the content generator 620 may execute on a different GPU 504.

The operation predictor 614 may be a generative AI model and/or a rules-based module that identifies one or more patterns in record data and/or profile data to determine one or more predicted operations, (e.g., processes that may be performed in the future). The record data may include operation data, such as usage data, transaction history, setting data, support interaction data, activity logs, etc. The profile data may include address data, preference data, one operational preference or operational preferences, personal attributes, etc. The predicted operations may be one or more computer operations or computer processes performed at a future time. The generative AI model may be trained with the rules-based module and/or may be trained based on record data associated with many entities to identify patterns in the operation data that predict the future operations. In some aspects, the generative AI model may operate in conjunction with the rules-based module. Although the predicted operations may occur in the future, in some cases, the predicted operations may not be completed.

Once the operation predictor 614 has been trained, the operation predictor 614 may be provided with record data from the logical storage 132 associated with the entity. The operation predictor 614 may process the operation data to determine the one or more predicted operations. For instance, a sequence of operations in the operation data may be identified by the operation predictor 614 that corresponds to a particular predicted operation. In some aspects, the operation predictor 614 may consume less computer and/or network resources than the predicted operations. For example, the sequence of operations may be a plurality of data transfers between logical storages 132 according to a schedule. The operation predictor 614 may determine a predicted operation to be a future data transfer occurring at a future scheduled time (e.g., monthly, annually, etc.). In another example, the sequence of operations may be a series of execution branches. The operation predictor 614 may determine the predicted operation to be a future branch decision.

In another example, the operation predictor 614 may identify that the sequence of operation data has stopped, such as the plurality of regular data transfers between the logical storages 132 stops. The operation predictor 614 may determine a predicted operation to be a completion of the process that performed the regular data transfers.

In yet another example, the sequence of operations may be a sequence of computer processes executed in a particular order. The operation predictor 614 may determine that the predicted operation be a future computer process for execution.

The artificial intelligence anonymizing engine 612 may be a generative AI model that may be trained to remove and/or obscure personally identifying data from the record data, the operation data, and/or the predicted operation. Once trained, the artificial intelligence anonymizing engine 612 may be provided with the portion of the data record used to generate the predicted operation and/or the predicted operation. The artificial intelligence anonymizing engine 612 may generate an anonymized dataset as the output. In some aspects, the artificial intelligence anonymizing engine 612 may be provided with one or more privacy legislation and/or regulations during the training process to train the engine 612 to comply with this legislation and/or regulations.

The artificial intelligence anonymizing engine 612 may be trained to obfuscate personally identifiable information (PII) while preserving the utility of the dataset for analytical purposes. The process commences with the identification and classification of sensitive attributes within the dataset, leveraging metadata schemas, and/or data dictionaries. In some aspects, these attributes may be subjected to cryptographic transformations, such as hashing and encryption, utilizing algorithms like SHA-256 and AES-256. These transformations may ensure that the original values are irreversibly altered, rendering them unrecognizable.

The artificial intelligence anonymizing engine 612 may perform named entity recognition, which scans the record data, the operation data, and/or the predicted operation to detect and/or classify entities, such as names, addresses, locations, phone numbers, etc. Additionally or alternatively, the artificial intelligence anonymizing engine 612 (i.e., AI anonymizing engine) may perform pattern matching to recognize one or more specific data formats, such as social security numbers, health card numbers, credit card details, etc.

Once the private data is identified, the artificial intelligence anonymizing engine 612 may remove or obscure the private data. For example, artificial intelligence anonymizing engine 612 may perform redaction where the private data is replaced with placeholders or blacked-out text. In another example, the artificial intelligence anonymizing engine 612 may perform anonymization by transforming the private data so the transformed data cannot be traced back to an individual, such as substituting names with pseudonyms or data masking. In yet another example, the artificial intelligence anonymizing engine 612 may perform differential privacy by introducing noise to the private data thereby reducing the possibility of identifying individual entries while still enabling execution of the predicted operation. One example may be perturbation by adding random noise to the private data to prevent exact identification.

In some aspects, the artificial intelligence anonymizing engine 612 may perform a pseudonymization rather than or in addition to anonymization. The private data may be replaced with one or more tokens. In some aspects, the tokens may be generated by encrypting the private data, such as encrypting the private data with Advanced Encryption Standard (AES) encryption. The tokens may be decrypted back to the private data with a decryption key. In some aspects, the tokens may be generated by a one-way hash function, such as SHA-256 (Secure Hash Algorithm 256-bit) or the like. The hashing is irreversible preventing the private data from being retrieved from the token. In some aspects, the tokens may be generated by a format-preserving encryption to preserve the data format.

In some aspects, the artificial intelligence anonymizing engine 612 may be trained with statistical methods to apply differential privacy mechanisms. Techniques such as k-anonymity, l-diversity, and t-closeness may be implemented to mitigate the risk of re-identification. These methods may involve the perturbation of data through noise addition, generalization, and suppression, ensuring that individual records cannot be distinguished within the dataset. The anonymized data may be validated through rigorous testing, employing metrics like information loss and disclosure risk to assess the efficacy of the artificial intelligence anonymizing engine 612.

The anonymized dataset may be stored in a secure, access-controlled environment, utilizing data governance frameworks to enforce compliance with regulatory standards such as General Data Protection Regulation (GDPR) and/or the privacy act. The anonymized dataset may be made available for analytical queries through secure APIs, ensuring that only authorized users can access the data. Continuous monitoring and auditing mechanisms may be established to detect and respond to any potential breaches, ensuring the ongoing integrity and confidentiality of the anonymized data.

The content generator 620 may include a multimodal large language model (LLM) trained to provide one or more artificially generated responses to the entity. The content generator may have been previously trained on a large dataset of text data. During the training, the text data may be broken down into tokens and transformed into multi-dimensional vector representations known as embeddings. The vector may capture a semantic meaning and/or relationships between the other tokens. Tokens having similar meaning and/or frequently appear in similar context may have embeddings that are close together in the multi-dimensional vector space.

The content generator 620 may comprise one or more encoders that may use one or more attention mechanisms, such as used in transformer architectures. The attention mechanisms enable the LLM to weigh an importance of different tokens in a sequence. During training, the attention weights may be dynamically adjusted to capture complex relationships and/or dependencies between tokens. The training process is an iterative process of adjusting embeddings and/or attention weights to refine the mathematical model of language to generate coherent, meaningful text. The content generator 620 may be trained to deanonymize the predicted operation and/or the one or more outputs.

Once trained, the content generator 620 may generate a response for a received input. The received inputs may be converted into tokens and the tokens may be encoded using the encoder of the content generator 620. After encoding the received input, the LLM may iteratively generate a sequence of response embeddings. A decoder may transform the response embeddings into a sequence of response tokens. A post-processing may be performed to detokenize the response tokens into words and sentences.

In this aspect, the content generator 620 may be provided with the shareable data record (e.g., the anonymized dataset and the predicted operation), at least a portion of the record data used to generate the predicted operation, at least a portion of the operation data used to generate the predicted operation, the predicted operation, and/or one or more outputs received from the third-party computer systems 120. The content generator 620 may generate a customized output from the provided input data. The customized output may be deanonymized and/or personalized to the entity by incorporating private data and/or personalized data into the customized output.

In this aspect, the customized output is a textual response. In other aspects, the content generator 620 may operate in conjunction with a text-to-speech engine to transform the textual response into an audio response. The speech-to-text engine may process the audio queries by filtering the audio signal, performing feature extraction, performing acoustic modelling, performing language modelling, and/or decoding. In some aspects, a translation engine may perform translation from one language into another language and vice versa.

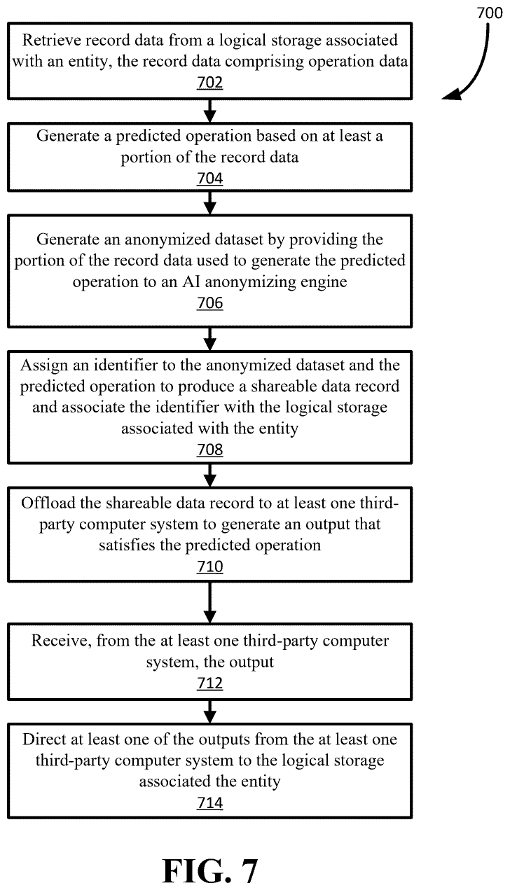

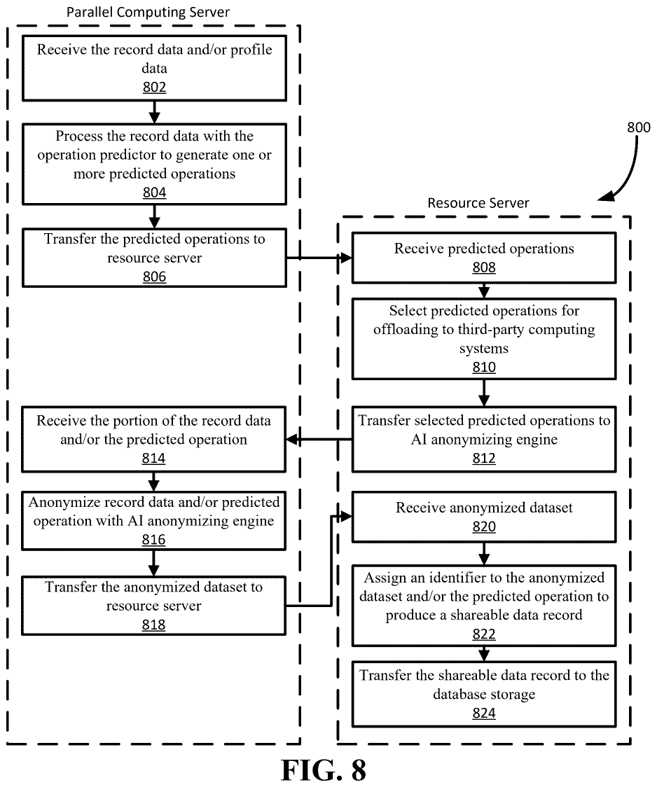

Although the steps in FIGS. 7-10 are shown in a particular order and in particular figures, this is not intended to be limiting. Steps from one of the figures may be used in combination and/or replacement for steps in the other figures and vice versa.

Turning to FIG. 7, an offloading process 700 may involve the resource server 130 retrieving record data from the logical storage 132 at step 702. The record data may be associated with an entity having an account with the resource server 130. The record data may comprise private data (e.g., personal data), operation data, such as usage data, transaction history, setting data, support interaction data, activity logs, etc. The record data may be time limited, such as monthly record data, quarterly record data, annual record data, etc. The record data may be provided to the operation predictor 614, such as previously described. The operation predictor 614 may generate one or more predicted operations based on at least a portion of the record data at step 704. In some aspects, the predicted operations may be executed by the resource server 130 when the resource server 130 has available computing resources.

Once the predicted operations are generated at step 704, the portion of the record data used to generate the predicted operations may be provided to the artificial intelligence anonymizing engine 612 at step 706. In this aspect, the artificial intelligence anonymizing engine 612 may be executing on the resource server 130. Other aspects, as described with reference to FIG. 8 below, may have the artificial intelligence anonymizing engine 612 executing on the parallel computing server 140. As previously described, the artificial intelligence anonymizing engine 612 may identify private data within the record data and/or the predicted operations and may obscure and/or remove the private data therefrom to generate the anonymized dataset.

At step 708, the anonymized dataset and the predicted operation may be assigned an identifier to produce a shareable data record. The shareable data record may contain no plaintext private data. In some aspects, the identifier may be an alphanumeric identifier that allows the resource server 130 to identify the account in the logical storage 132 associated with the record data that was used to generate the predicted operations and/or the entity. In some aspects, the identifier may be an encrypted and/or hashed identifier produced from encrypting and/or hashing the private data.

In an aspect, the shareable data record may be made available to one or more third-party computer systems 120. In this aspect, the shareable data record may be stored on the logical storage 132 associated with the resource server 130 for retrieval by the third-party computer systems 120. In some aspects, the resource server 130 may place access controls on the shareable data records such that the third-party computer systems 120 may be required to login to the resource server 130 via a third-party account. In other aspects, the shareable data records may be made available without access controls as the shareable data records contain no personally identifiable information (e.g. private data). In another aspect, the shareable data records may be pushed to the third-party computer systems 120.

At step 710, the shareable data record may be offloaded by the resource server 130 to one or more of the third-party computer systems 120. In some aspects, the resource server 130 may obtain from the third-party computer systems 120, third-party processing capabilities, such as processing hardware, processing software, performance data, etc. The offloading may be determined, at least in part, by the third-party processing capabilities. In some aspects, the third-party computer system 120 may evaluate the shareable data record to determine suitability for processing by the third-party computer system 120. For instance, the third-party computer system 120 may apply one or more filters to the shareable data records to identify the suitability for processing and may select only the shareable data records that pass through the filters. In one example, the shareable data record may comprise one or more categories, such as industry area. The third-party computer system 120 may be configured to process medical record and may set the industry area filter to specify that only medical records are to be retrieved and/or processed by the third-party computer system 120. In some aspects, the resource server 130 may perform a categorization of the shareable data records to generate the filters provided to the third-party computer systems 120.

Once the shareable data record has been selected by the third-party computer system 120, the third-party computer system 120 may execute the predicted operation of the shareable data records to generate one or more outputs that satisfy the predicted operation. In some aspects, the third-party computer system 120 may retrieve one or more process instructions and/or third-party data from the third-party logical storage 122 for processing the predicted operation. Once complete, in some aspects, the third-party computer system 120 may store the outputs to the third-party logical storage 122.

At step 712, the third-party computer system 120 may transfer the outputs with the identifier to the resource server 130 where the resource server 130 receives the outputs. In response to receipt of the outputs and the identifier, the resource server 130 may direct at least one of the outputs from the third-party computer system 120 to the logical storage 132 associated with the entity at step 714. The identification of the logical storage 132 may be based on the identifier provided by the third-party computer system 120.

The resource server 130 may generate recommendations of one of the outputs being stored in the logical storage 132 associated with the entity. The recommendations may be generated based on filtering the outputs using a personal preference profile. In particular, the outputs from multiple third-party computer systems 120 may be processed and a subset of the outputs may be identified based on preference information contained in the personal preference profile.

In some embodiments, the selection of recommended output may be made by assigning, for each of one or more of the outputs, a preference score. The preference score may represent an estimate of the preference for the output based on the personal preference profile. The preference score for the output may be determined in various different ways. In some aspects, an affinity value may be assigned to each of one or more attributes of the output, where the affinity value represents an entity's affinity for an attribute. The preference score for the output may be determined based on the assigned affinity values for the attributes. For example, a weighted sum of the assigned values of an output's attributes may be computed and set as the preference score for the output. The weights may, for example, correspond to attribute preference scores for the attributes as indicated in the personal preference profile. In this way, the preference score may reflect the relative importance of each of the output's attributes for the entity. For example, in a medical field, the medical professional may prefer early detection over accuracy and therefore, outputs with attributes of earlier detection may be selected or ranked over those having higher accuracy.

In some aspects, the offloading process 700 may be a batch process that processes record data for a plurality of accounts.

Turning to FIG. 8, another offloading process 800 is shown demonstrating the resource server 130 operating in conjunction with the parallel computing server 140. In this aspect, the parallel computing server 140 receives the record data and/or the profile data from the resource server 130 at step 802. The resource server 130 may transmit the record data and/or the profile data via a secure network connection over the network 150 to the parallel computing server 140. The secure network connection may comprise a virtual private network and/or bank-grade security.

At step 804, the parallel computing server 140, executing the operation predictor 614 as previously described, may process the record data to generate one or more predicted operations based on the record data. At step 806, the parallel computing server 140 may transfer the predicted operations to the resource server 130 via the secure network connection where the predicted operations are received at step 808.

In this aspect at step 810, the resource server 130 may select one or more of the predicted operations for offloading to the third-party computer systems 120. In some aspects, the operation predictor 614 may provide a success score with the predicted operation to the resource server 130. The resource server 130 may select the predicted operations for offloading based on the success score exceeding a predetermined threshold (e.g., 75%, 80%, 85%, 90%, 95%, etc.). The predicted operations below the predetermined threshold may be discarded and/or added with the record data to a training database in the data resource 606 for retraining of the operation predictor 614. In some aspects, the operation predictor 614 may omit transferring predicted operations below the predetermined threshold to the resource server 130. Once the resource server 130 selects the predicted operations, the resource server 130 transfers the selected predicted operations to the parallel computing server 140 at step 812 where the selected predicted operations are received at step 814 to be processed by the artificial intelligence anonymizing engine 612.

In some aspects, the parallel computing server 140 may perform the selection based on the predetermined threshold rather than the resource server 130. In this aspect, the predicted operations may be provided directly to the artificial intelligence anonymizing engine 612 thereby saving bandwidth and/or latency in transferring the predicted operations to the resource server 130 for selection.

At step 816, the artificial intelligence anonymizing engine 612 may process the record data, profile data, and/or the predicted operation. As previously described, the artificial intelligence anonymizing engine 612 may identify private data within the record data, profile data, and/or the predicted operations and may obscure and/or remove the private data therefrom to generate the anonymized dataset. At step 818, the anonymized dataset may be transferred to the resource server 130 via the network 150 where the anonymized dataset is received by the resource server 130 at step 820. As the anonymized dataset no longer contains private data, the transfer at steps 818 and 820 may be performed without using the secure network connection thereby saving processing to encrypt the anonymized dataset.

At step 822 (like step 708), the anonymized dataset and the predicted operation may be assigned an identifier to produce a shareable data record. The shareable data record may contain no plaintext private data. In some aspects, the identifier may be an alphanumeric identifier that allows the resource server 130 to identify the account in the logical storage 132 associated with the record data that was used to generate the predicted operations and/or the entity. In some aspects, the identifier may be an encrypted and/or hashed identifier produced from encrypting and/or hashing the private data.

In an aspect, the shareable data record may be made available to one or more third-party computer systems 120 on a database storage 180 at step 824. The database storage 180 may be separate from the logical storage 132 associated with the entity. The database storage 180 may be accessible to the third-party computer system(s) 120. In some aspects, the database storage 180 may generate at least one classification for the predicted operations stored thereon. A plurality of the shareable data records may be collated by the database storage 180 into the classifications. In some aspects, the database storage 180 may provide a notification to the third-party computer systems 120. The third-party computer systems 120 may have previously subscribed to receive notifications when new shareable data records are added to subscribed classifications. In some aspects, the database storage 180 may automatically push the collated shareable data records to the third-party computer systems 120.

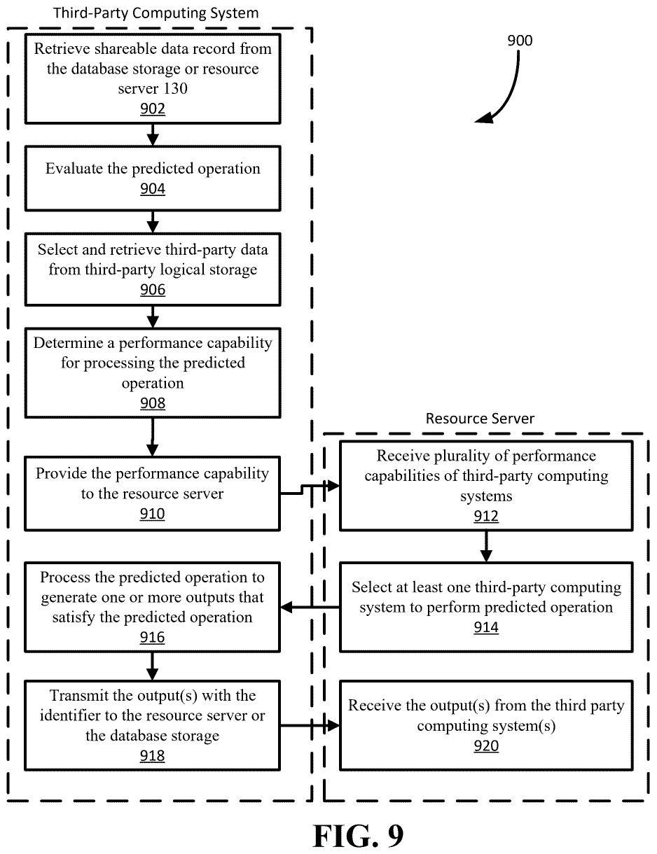

Although not shown in FIG. 8, the third-party computer system 120 may process the shareable data record as previously described in steps 710, 712, 714 with reference to FIG. 7. Alternatively or additionally, the third-party computer system 120 may perform the steps as shown in FIG. 9 described below.

Turning to FIG. 9, an offload process 900 demonstrating operation of the third-party computer system 120 in conjunction with the resource server 130 is shown. In this aspect at step 902, the third-party computer system 120 may retrieve the shareable data record from the database storage 180 and/or the resource server 130.

At step 904, the third-party computer system 120 may evaluate the shareable data record to determine suitability for processing by the third-party computer system 120. For instance, the third-party computer system 120 may apply one or more filters to the shareable data records to identify the suitability for processing and may select only the shareable data records that pass through the filters. In one example, the shareable data record may comprise one or more categories, such as industry area. The third-party computer system 120 may be configured to process medical record and may set the industry area filter to specify that only medical records are to be retrieved and/or processed by the third-party computer system 120. In some aspects, the resource server 130 may perform a categorization of the shareable data records to generate the filters provided to the third-party computer systems 120. In some aspects, the third-party computer system 120 may determine a score for the shareable data record based on predetermined criteria. The third-party computer system 120 may only select the shareable data record(s) based on the score exceeding a predetermined threshold.

In some aspects, the third-party computer system 120 may retrieve one or more process instructions and/or third-party data from the third-party logical storage 122 for processing the predicted operation at step 906.

Once the shareable data record has been selected by the third-party computer system 120, at step 908, the third-party computer system 120 may determine a performance capability for processing the predicted operation. For example, the third-party computer system 120 may determine an expected latency to process the predicted operation. Other examples of performance capabilities may include response time, throughput, latency, completion time, service time, bandwidth, performance per Watt, etc. In another example, the third-party computer system 120 may provide a selection of algorithms as the performance capability. The selection of algorithms may be retrieved from the third-party logical storage 122 for processing the predicted operation. In yet another example, the third-party computer system 120 may determine an accuracy, error rate, precision, and/or consistency of the output for processing the predicted operation. In some aspects, the performance capability may include a cost to the resource server 130. In some aspects, the cost may be positive or negative indicating the direction of currency transfer to or from the resource server 130. In some aspects, the provider of the resource server 130 and/or the parallel computing server 140 may provide compensation to the third party for the third-party computer system 120 to execute the predicted operations. In some aspects, the third party may provide compensation to the provider of the resource server 130 and/or the parallel computing server 140 for executing the predicted operations.

In another aspect, the resource server 130 may request the performance capabilities from the third-party computer system 120 in advance, such as during registration of the third-party computer system 120 with the resource server 130. The resource server 130 may generate specific queries for transmitting to the third-party computer systems 120 to retrieve the processing capabilities. Although the resource server 130 may not be provided with real-time performance characteristics, this technique of advanced retrieval of performance capabilities from the third-party computer systems 120 may may help to increase efficiency in data processing for the resource server 130 as the resource server 130 is not receiving the performance capabilities for each of the shareable data records. For example, at registration with the resource server 130, the third-party computer system 120 may provide their performance capabilities, such as average response time, average throughput, average latency, average completion time, average service time, average bandwidth, average performance per Watt, etc.

In yet another aspect, the resource server 130 may provide a benchmarking process to the third-party computer system 120 to determine the performance capabilities of the third-party computer system 120.

At step 910, the third-party computer system 120 may transmit the performance capability to the resource server 130. At step 912, the resource server 130 may receive a plurality of performance capabilities from one or more third-party computer system 120. In some aspects, the resource server 130 may set a deadline for each of the predicted operations. The resource server 130 may accept receipt of the performance capabilities from the third-party computer systems 120 until the deadline is reached.

At step 914, the resource server 130 may evaluate and/or compare the performance capabilities to each other and select one or more of the third-party computer systems 120 to perform the predicted operation in accordance with their respective performance capabilities. The resource server 130 may weight different performance metrics from the performance capabilities based on a desired performance in executing the predicted operations. In some aspects, the resource server 130 may maintain a historical performance metric for each of the third-party computer systems 120 based on their ability to meet their specified performance capabilities. The historical performance metric may determine a reliability of the third-party computer system 120 and/or may influence selection of the third-party computer system 120. Once selected, the resource server 130 may transmit a notification to the selected third-party computer systems 120.

At step 916, the third-party computer system 120 may execute the predicted operation of the shareable data records to generate one or more outputs that satisfy the predicted operation. In some aspects, the third-party computer system 120 may be required to process the predicted operation in accordance with the performance capability provided to the resource server 130. Once complete, in some aspects, the third-party computer system 120 may store the outputs to the third-party logical storage 122.

At step 918, the third-party computer system 120 may transfer the outputs with the identifier to the resource server 130 where the resource server 130 receives the outputs at step 920. The resource server 130 may evaluate the outputs in comparison to the performance capabilities provided to the resource server 130. The resource server 130 may flag and/or discard one or more non-compliant outputs that do not meet the specified performance capabilities. In some aspects, the resource server 130 may evaluate the outputs from different third-party computer systems 120. For example, the resource server 130 may perform a statistical analysis (e.g., t-tests, ANOVA (Analysis of Variance), chi-square tests, etc.), cross-validation (k-fold cross-validation), error analysis, etc. on the outputs. In some aspects, the resource server 130 may discard the outputs that are outliers. In some aspects, the resource server 130 may combine the outputs, such as by aggregation, weighted averaging, voting, Bayesian averaging or networks, Kalman filters, decision trees, and/or machine learning techniques.

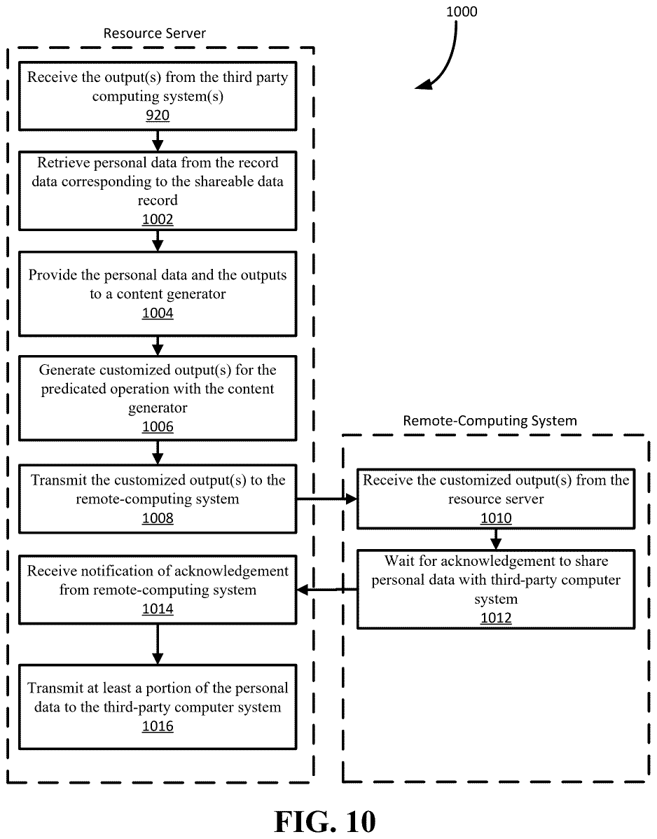

In response to receipt of the outputs and the identifier, the resource server 130 may direct at least one of the outputs from the third-party computer system 120 to the logical storage 132 associated with the entity as previously described with reference to step 714. The identification of the logical storage 132 may be based on the identifier provided by the third-party computer system 120. Alternatively or additionally, the resource server 130 may perform the steps as shown in FIG. 10 described below.

Turning to FIG. 10, a personalization process 1000 demonstrating operation of the resource server 130 in conjunction with the remote-computing system 110 is shown. The personalization process 1000 may start with receiving one or more outputs from the third-party computer systems 120, as previously described in step 920.

At step 1002, the resource server 130 may retrieve personal data associated with the record data corresponding to the shareable data record. In some aspects, the personal data may be retrieved from the logical storage 132. In some aspects, the personal data may be retrieved from the private data that was removed or obscured by the artificial intelligence anonymizing engine 612 when generating the shareable data record. The private data may be decrypted to provide the personal data.

At step 1004, the personal data and the output(s) may be provided to the content generator 620. In some aspects, the content generator 620 may be located within the resource server 130. In some aspects, the resource server 130 may transmit the personal data and the output(s) to the parallel computing server 140 that is executing the content generator 620. In some aspects, the resource server 130 may evaluate the output(s) to determine an operational score. In some aspect, the operational score may be the accuracy of the output. In some aspects, the resource server 130 may determine the operational score based on one or more preferences stored in the profile of the entity. The operational score may be compared to an operational threshold. In response to exceeding the operational threshold, the output may be provided to the content generator 620.

At step 1006, the content generator 620 may process the personal data and the output(s) to generate one or more customized output(s) for the predicted operation. The customized output(s) may inject the personal data into the output to generate the customized output(s).

Once the customized output(s) have been generated, at step 1008, the customized output(s) may be transmitted to the remote-computing system 110 associated with the entity by the resource server 130 via the network 150. The resource server 130 may provide the customized output(s) by way of a push notification. A selection of the push notification by the remote-computing system 110 may retrieve the output(s) from the resource server 130. In aspects where the content generator 620 is executing on the parallel computing server 140, the customized output(s) may be transmitted to the remote-computing system via the resource server 130. In other aspects, the customized output(s) may be stored in the logical storage 132 until such time as the remote-computing system 110 access the resource server 130. When the remote-computing system 110 accesses the resource server 130, the remote-computing system 110 may retrieve the customized output(s).

At step 1010, the remote-computing system 110 may receive the customized output(s) from the resource server 130. The remote-computing system 110 may display or provide the customized output(s) by way of the output interface module 220. The customized output(s) may be converted into speech with a text-to-speech conversion. The remote-computing system 110 may play the speech via the output interface module 220, such as a speaker and/or headphones. In some aspects, more than one of the customized outputs may be displayed in a list. In some aspects, the remote-computing system 110 may wait for a selection of one of the customized outputs by the entity using the input interface module 230. On selection of one of the customized outputs, the output interface module 220 may display further details of the customized output.

In some aspects, the resource server 130 may determine an order of preference associated with the plurality of outputs. The order may be determined, for example, using a personal preference profile. For example, a preference score may be assigned to each of the plurality of outputs, and the order of the list may be determined based on the respective preference scores. The remote-computing system 110 may present the list of the outputs based on the determined order of preference. For example, a listing of the outputs may be displayed, where the outputs are initially ordered according to the determined order of preference. In some aspects, an output comparison view for comparing select ones of the plurality of outputs may be presented on remote-computing system 110.

In some aspect, the outputs may be provided in a graphical user interface associated with an application 410, such as a mobile or web application, for accessing account data from the resource server 130. The entity may access, via a user interface of the application 410 on the remote-computing system 110, the output. For example, the outputs may include a subset of outputs that are associated with highest levels of preference (e.g. a higher preference score) and display the subset on the user interface.

The display of a recommended output may be distinguished from display of other outputs. In particular, the recommended outputs may be displayed differently than other outputs. For example, the recommended output may be displayed in a region of the graphical user interface that is separated from one or more regions displaying other outputs. That is, the display of the recommended output may be locationally distinct from the display of the other outputs on the user interface. As another example, the recommended output may be prioritized in a display order (i.e., displayed with higher priority) of the list of all outputs provided by the third-party computer systems 120.

Additionally, or alternatively, the recommended output may be provided as notifications on the remote-computing system 110. In some aspects, the recommended output may be included in push notifications provided to the remote-computing system 110. The push notifications may be provided, for example, in response to detecting one or more defined trigger conditions. In particular, the resource server 130 may detect a trigger condition associated with one or more outputs of the selected subset of outputs (i.e., recommended output) and in response to detecting the trigger condition, the recommendations of output may be provided on the remote-computing system 110. The trigger condition may, for example, receiving an output that satisfies a personal preference profile.

At step 1012, the remote-computing system 110 may wait for an acknowledgement from the entity using the input interface module 230. The acknowledgement may indicate that the entity approves of sharing personal data with the third-party computer system 120. In response to the acknowledgement, the remote-computing system 110 may transmit a notification of acknowledgement via the network 150 to the resource server 130. In some aspects, the remote-computing system 110 may provide a list of personal data and the entity may select from the list, the personal data with which the entity approves to share with the third-party computer system 120.

At step 1014, the resource server 130 may receive the notification of acknowledgement from the remote-computing system. In response, the resource server 130 may transmit at least a portion of the personal data to the third-party computer system 120 at step 1016. In aspects where the notification of acknowledgement includes the list of personal data that has been approved for sharing, the resource server 130 may only transmit the approved personal data to the third-party computer system 120. In some aspects, the resource server 130 may perform a data transfer from the logical storage 132 associated with the entity to the third-party logical storage 122. In some aspects, the resource server 130 may apply a modifier to the data transfer thereby transferring the modifier into a server-provider logical storage (not shown).

Although not shown, once the third-party computer system 120 received the personal data, the third-party computer system 120 may perform further computer operations, such as computing further outputs to be provided to the resource server 130 and/or the remote-computing system 110.

The techniques described herein may be applicable to different industries. Some examples include healthcare, education, financial, and/or any other industry subject to privacy concerns and processing significant amounts of data in an anticipatory manner.

In a medical example, the resource server 130 may manage electronic health records stored in the logical storage 132. The resource server 130 may provide the electronic health records to the operation predictor 614 to generate the predicted operations. The electronic health records may be evaluated to predict one or more conditions of the patient associated with the electronic health record. The prediction score of the condition may be low at this stage. Based on the electronic health record and/or the conditions, the operation predictor 614 may generate one or more tests and/or computer processes to confirm the condition with a higher certainty. For example, one of the predicted operations generated may be to process image data from a plurality of image scans to identify a progression of the condition. The processing of the image data may consume considerable computing resources.

Before the image data may be shared with third-party computer systems 120, the image data may be provided to the artificial intelligence anonymizing engine 612 to remove any private data associated with the patient. The anonymized image data and the predicted operation may then be provided to the third-party computer systems 120. The third-party computer system 120 may perform medical research for the predicted condition. The third-party computer system 120 may comprise available resources to process the image data from the image scans. The third-party computer system 120 may retrieve specialized algorithms from the third-party logical storage 122 that may not be available to the resource server 130 and/or the parallel computing server 140. The specialized algorithms, when executed by the third-party computer system 120 may confirm the condition. The output from the specialized algorithms may be provided to the resource server 130.

In a financial example, the resource server 130 may manage transaction records stored in the logical storage 132. The resource server 130 may provide the transaction records to the operation predictor 614 to generate a predicted risk associated with an account. The transaction records may be evaluated to predict one or more risk factors associated with the account linked to the transaction record. Based on the transaction record and/or the risk factors, the operation predictor 614 may generate one or more complex processes to confirm the risk with higher certainty. For example, one of the predicted operations generated may be to analyze transaction patterns from a plurality of accounts to identify potentially fraudulent activity. The analysis of the transaction patterns across the plurality of accounts may consume considerable computing resources.

Before the transaction data may be shared with third-party computer systems 120, the transaction data may be provided to the artificial intelligence anonymizing engine 612 to remove any private data associated with the entity. The transaction data and the predicted operation may then be provided to the third-party computer systems 120. The third-party computer system 120 may perform financial analysis for the predicted risk. The third-party computer system 120 may comprise available resources to analyze the transaction patterns from the accounts. The third-party computer system 120 may confirm the risk by performing the predicted operation on the transaction data. The output may be transferred to the resource server 130. The risk may be aggregated across the outputs from a plurality of third-party computer systems 120.

In yet another example, the resource server 130 may provide the transaction data to the operation predictor 614. The operation predictor 614 executing on the parallel computing server 140 may ingest the transactional data through a robust ETL (Extract, Transform, Load) pipeline. The extraction phase may involve collecting the raw transactional data from various sources, such as databases, APIs, and flat files, stored on the logical storage 132. This data may be pulled into the ETL pipeline using connectors and/or data ingestion tools, such as Apache Kafka, Apachi NiFi, AWS Glue, Integrate.io, and/or Airbyte. The extraction phase gathers the relevant data into a cache location for further processing. In the transformation phase, the raw data may undergo several processing steps to convert the raw data into a usable format by the operation predictor 614. This includes data cleaning (e.g., removing duplicates, handling missing values), normalization (e.g., standardizing data formats), and enrichment (e.g., adding additional information such as timestamps and geolocation). Complex transformations may also involve aggregating data, performing calculations, and/or applying rules. The transformed data may be structured in a way that is optimized for analysis and reporting. The load phase may load the transformed data into a target data warehouse or database. This step may involve writing the processed data into storage systems that are designed for high-performance querying and analysis. The data warehouse, such as Amazon Redshift or Google BigQuery, may allow for efficient retrieval and manipulation of the data for various analytical purposes. The loading process ensures that the data is readily available for downstream applications, such as machine learning models and reporting tools. In some aspect, the operation predictor 614 may identify one or more temporal achievement markers from the transaction data. The temporal achievement markers may correspond to one or more predicted operations to be performed.

The transaction data associated with the temporal achievement markers and the one or more predicted operations may be provided to the artificial intelligence anonymizing engine 612 to remove the private data. The anonymized dataset may be transferred to one or more third-party computer systems 120 executing an algorithmically-driven advisory engine. The algorithmically-driven advisory engine may evaluate the temporal achievement markers and the one or more predicted operations to identify one or more algorithmically-generated item advisories (e.g., the output).

The algorithmically-driven advisory engine may aggregating data from various sources, such as demographic information, transaction histories from a plurality of entities. One or more relevant features may be extracted from the temporal achievement markers and/or the predicted operations to represent preferences and attributes. This process may involve creating variables that capture aspects of the data, such as purchase frequency, item categories, and/or user ratings. The algorithmically-driven advisory engine may execute machine learning algorithms, including collaborative filtering, content-based filtering, and/or hybrid models, previously trained to provide algorithmically-generated item advisories. In some aspects, the third-party computer system 120 may include a third-party parallel computing server, such as the parallel computing server 140 as previously described. The third-party computer system 120 may generate algorithmically-generated item advisories for the predicted operation. These algorithmically-driven item advisories may be delivered to the resource server 130.

The resource server 130 may provide the algorithmically-driven item advisories to the content generator 620 to inject the personal data into the algorithmically-driven item advisories for delivery to the remote-computing system 110. The customized algorithmically-driven item advisories may be provided to the remote-computing system 110 via various channels, such as e-commerce platforms, mobile apps, and/or email notifications. The resource server 130 may collect feedback from remote-computing system 110 to refine and improve the algorithmically-driven advisory engine.

Although the aspects herein refer to the resource server 130, the third-party computer system 120, the parallel computing server 140, and/or the remote-computing system 110 as executing the processes, operations, and/or processor-executable instructions, this phrasing is merely for convenience. The processes, operations, and/or processor-executable instructions are executed by a processor or GPU within the respective computing system.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

A storage medium may be coupled to the processor such that the processor may read information from, and write information to, the storage medium. In the alternative, the storage medium and the processor may share the same die. The processor and the storage medium may reside in an application specific integrated circuit (“ASIC”). In the alternative, the processor and the storage medium may reside as discrete components.

The aspects herein may execute on a cloud computing platform with on-demand availability of computer system resources, including data storage, and computing power, with automated active management. Clouds are often distributed, with data centers in multiple locations for availability and performance. Computing resources on clouds are shared across multiple tenants through virtual computing environments comprising virtual machines, databases, containers, and other resources. A container is an isolated, lightweight software for running an application on the host operating system. Containers are built on top of the host operating system's kernel and contain applications and some lightweight operating system APIs and services. Virtual machines are a software layer which include a complete operating system and kernel. Virtual machines are built on top of a hypervisor emulation layer designed to abstract a host computer's hardware from the operating software environment. Clouds generally offer hosted databases abstracting high-level database management activities.

Although an aspect of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the remote-computing system 110 may be embodied as a personal computer, a server, a console, a personal digital assistant (PDA), a cell phone, a tablet computing device, a smartphone, or any other suitable computing device, or combination of devices. The presentation of the above-described functions as being performed by the remote-computing system 110 and/or resource server 130 is not intended to limit the scope of the present application but rather to provide one example among many possible embodiments. Indeed, the methods, systems, and apparatuses disclosed herein may be implemented in both localized and distributed forms, consistent with computing technology.

Some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of processor-executable instructions that may, for instance, be organized as an object, procedure, or function. The executables of an identified module may not be physically located together but may comprise disparate processor-executable instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single processor-executable instruction or many processor-executable instructions and may even be distributed over several different code segments, among different programs, and across several memory devices. Similarly, operational data may be identified and illustrated herein within modules and may be embodied in any suitable form and organized within any suitable type of data structure. The operational data may be collected as a single dataset or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these aspects, it would be apparent to those of skill in the art that modifications, variations, and alternative constructions would be apparent.

While aspects of the present application have been described, it is to be understood that the aspects described are illustrative, and the scope of the application is to be defined solely by the appended claims when considered with a full range of equivalents and modifications (e.g., protocols, hardware devices, software platforms, etc.) thereto.

The various embodiments presented above are merely examples and do not limit the scope of this application. Variations of the innovations described herein will be apparent to persons of ordinary skill in the art, such variations being within the intended scope of the present application. Features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application in its entirety. The subject matter described herein and in the recited claims intends to cover and embrace any changes in technology.

1. A server comprising:
a communications module;
at least one processor coupled to the communications module; and
a memory coupled to the at least one processor, the memory storing a plurality of processor-executable instructions which, when executed, configure the at least one processor to:
retrieve record data from a logical storage associated with an entity, the record data comprising operation data;
generate a predicted operation based on at least a portion of the record data;
generate an anonymized dataset by providing the portion of the record data used to generate the predicted operation to an artificial intelligence anonymizing engine;
assign an identifier to the anonymized dataset and the predicted operation to produce a shareable data record and associate the identifier with the logical storage associated with the entity;
offload the shareable data record to at least one third-party computer system to generate an output that satisfies the predicted operation;
receive, from the at least one third-party computer system, the output; and
direct at least one of the outputs from the at least one third-party computer system to the logical storage associated the entity.

2. The server of claim 1, the processor-executable instructions, when executed, further configure the at least one processor to:
store the shareable data record in a database storage, the database storage being separate from the logical storage associated with the entity and the database storage accessible to the at least one third-party computer system.

3. The server of claim 1, the processor-executable instructions, when executed, further configure the at least one processor to:
generate, by a content generator, a customized output for the predicted operation by injecting personal data from the record data into the output.

4. The server of claim 3, the processor-executable instructions, when executed, further configure the at least one processor to:
transmit the customized output to a remote-computing system associated with the logical storage;
request an acknowledgement of the customized output to initiate a transfer of the personal data to the third-party computer system associated with the customized output; and
receive the acknowledgement from the remote-computing system responsive to a selection by the remote-computing system.

5. The server of claim 4, the processor-executable instructions, when executed, further configure the at least one processor to:
responsive to the acknowledgement, transmit the personal data of the entity to the third-party computer system.

6. The server of claim 5, the processor-executable instructions, when executed, further configure the at least one processor to:
responsive to the acknowledgement, perform a data transfer from the logical storage to a third-party logical storage; and
apply a modifier to the data transfer thereby transferring the modifier into a server-provider logical storage.

7. The server of claim 3, the processor-executable instructions, when executed, further configure the at least one processor to:
determine an operational score for the output; and
direct the output to the content generator responsive to the operational score exceeding an operational threshold.

8. The server of claim 1, wherein the predicted operation is generated by an artificial intelligence engine based on at least the portion of the record data and a profile associated with the logical storage, the profile comprising at least one operational preference.

9. The server of claim 1, the processor-executable instructions, when executed, further configure the at least one processor to:
determine a score for the shareable data record; and
share the shareable data record with the third-party computer system responsive to the score exceeding a threshold.

10. The server of claim 1, the processor-executable instructions, when executed, further configure the at least one processor to:
generate at least one classification for the predicted operation;
collate a plurality of the shareable data record based on the at least one classification; and
provide the plurality of the shareable data record to the at least one third-party computer system.

11. A computer-implemented method comprising:
retrieving record data from a logical storage associated with an entity, the record data comprising operation data;
generating a predicted operation based on at least a portion of the record data;
generating an anonymized dataset by providing the portion of the record data used to generate the predicted operation to an artificial intelligence anonymizing engine;
assigning an identifier to the anonymized dataset and the predicted operation to produce a shareable data record and associate the identifier with the logical storage associated with the entity;
offloading the shareable data record to at least one third-party computer system to generate an output that satisfies the predicted operation;
receiving, from the at least one third-party computer system, the output; and
directing at least one of the outputs from the at least one third-party computer system to the logical storage associated the entity.

12. The computer-implemented method of claim 11, further comprising:
storing the shareable data record in a database storage, the database storage being separate from the logical storage associated with the entity and the database storage accessible to the at least one third-party computer system.

13. The computer-implemented method of claim 11, further comprising:
generating, by a content generator, a customized output for the predicted operation by injecting personal data from the record data into the output.

14. The computer-implemented method of claim 13, further comprising:
transmitting the customized output to a remote-computing system associated with the logical storage;
requesting an acknowledgement of the customized output to initiate a transfer of the personal data to the third-party computer system associated with the customized output; and
receiving the acknowledgement from the remote-computing system responsive to a selection by the remote-computing system.

15. The computer-implemented method of claim 14, further comprising:
responsive to the acknowledgement, transmitting the personal data of the entity to the third-party computer system.

16. The computer-implemented method of claim 15, further comprising:
performing a data transfer from the logical storage to a third-party logical storage responsive to the acknowledgement; and
applying a modifier to the data transfer thereby transferring the modifier into a server-provider logical storage.

17. The computer-implemented method of claim 13, further comprising:
determining an operational score for the output; and
directing the output to the content generator responsive to the operational score exceeding an operational threshold.

18. The computer-implemented method of claim 11, wherein the predicted operation is generated by an artificial intelligence engine based on at least the portion of the record data and a profile associated with the logical storage, the profile comprising at least one operational preference.

19. The computer-implemented method of claim 11, further comprising:
determining a score for the shareable data record; and
sharing the shareable data record with the third-party computer system responsive to the score exceeding a threshold.

20. A non-transitory computer readable storage medium comprising processor-executable instructions which, when executed, configure at least one processor to:
retrieve record data from a logical storage associated with an entity, the record data comprising operation data;
generate a predicted operation based on at least a portion of the record data;
generate an anonymized dataset by providing the portion of the record data used to generate the predicted operation to an artificial intelligence anonymizing engine;
assign an identifier to the anonymized dataset and the predicted operation to produce a shareable data record and associate the identifier with the logical storage associated with the entity;
offload the shareable data record to at least one third-party computer system to generate an output that satisfies the predicted operation;
receive, from the at least one third-party computer system, the output; and
direct at least one of the outputs from the at least one third-party computer system to the logical storage associated the entity.
